(19) United States
(12) Patent Application Publication
(10) Pub. No.: US 2020/0247227 A1
(43) Pub. Date: Aug. 6, 2020

(54) POWER SUPPLY SYSTEM

(71) Applicant: YAZAKI CORPORATION, Tokyo (JP)

(72) Inventors: Yuta KAWAMURA, Makinohara-shi (JP); Shinya Oda, Makinohara-shi (JP); Masahiro Ito, Makinohara-shi (JP)

(73) Assignee: YAZAKI CORPORATION, Tokyo (JP)

(21) Appl. No.: 16/857,529

(22) Filed: Apr. 24, 2020

Related U.S. Application Data
(63) Continuation of application No. PCT/JP2018/036546, filed on Sep. 28, 2018.

(30) Foreign Application Priority Data
Nov. 27, 2017 (JP) 2017-227195

(51) Int. Cl. B60K 1/04; B60R 16/02; B60L 50/64; B60L 53/14; B60L 58/10; B60R 16/03; H01M 2/10; H02J 50/12

(52) U.S. Cl. CPC B60K 1/04; B60R 16/0215; B60L 50/64; B60L 53/14; H01M 2220/20; B60R 16/03; H01M 2/1077; H02J 50/12; B60L 2240/54; B60L 58/10

(57) ABSTRACT

A power supply system includes a high voltage battery, a high-voltage power distribution unit that distributes high-voltage power supply from the high voltage battery, a power conversion unit that converts high-voltage power supply supplied from the high-voltage power distribution unit to low-voltage power supply, and a low-voltage power distribution unit that distributes low-voltage power supply from the power conversion unit. The high-voltage power distribution unit branches output into at least two systems and distributes the high-voltage power supply to a drive module for driving a vehicle by power of the high-voltage power supply and to the power conversion unit.

### CROSS-REFERENCE TO RELATED APPLICATIONS

The present application is a continuation application of PCT/JP2018/036546 that claims priority to Japanese Patent Application No. 2017-227195 filed on Nov. 27, 2017, the entire content of which is incorporated herein by reference.

### TECHNICAL FIELD

The present invention relates to a power supply system suitable for power supply on a vehicle.

### BACKGROUND

For example, in a case of an electric vehicle or a hybrid vehicle, an electric motor is employed as a drive source for generating a propulsive force, and thus a large amount of electric energy is required. Therefore, in general, in order to reduce the loss in a power source and a distribution path, for example, it is often configured to handle a high voltage of 200 [V] or more. On the other hand, various auxiliary machines (various electrical components) mounted on a vehicle are normally designed to operate with a low-voltage power of about 12 [V]. Therefore, in a case of a power supply system for an electric vehicle or a hybrid vehicle, both high voltage and low voltage can be supplied.

For example, a vehicle power device disclosed in Patent Literature 1 (JP-A-2016-222057) describes technology for saving space. The vehicle power supply device includes a high voltage J/B module, a DC/DC converter module, a control module, and a case. The control module controls a semiconductor switching element in the high voltage J/B module and also controls a semiconductor switching element in the DC/DC converter module. The case accommodates the high voltage J/B module, the DC/DC converter module, and the control module. Moreover, in the case, an installation location in which the high voltage J/B module and DC/DC converter module are installed is configured at least by a metal member and radiation fins are provided outside the case corresponding to the installation location.

Further, a vehicle system of Patent literature 2 (JP-A-2017-124700) describes technology which can perform communication even when devices having different protocols are mounted and efficiently combines vehicle modules to complete a vehicle. This vehicle system is modularized according to the assembly structure of a vehicle and includes a plurality of vehicle modules M and a trunk line TL. Each of the plurality of vehicle modules M has a gateway unit which is communicably connected to a plurality of devices having different protocols in the vehicle. The trunk line TL connects the gateway units of the vehicle modules M.

Moreover, a battery pack and a vehicle power system of Patent Literature 3 (JP-A-2017-139138) describe technology for appropriately stepping down the voltage from a high voltage battery. The battery pack includes a high voltage battery, a power converter, a battery pack ECU, and a housing B. The high voltage battery connects a plurality of unit cells C. The power converter is interposed between the high voltage battery and load to step down the voltage from the high voltage battery. The battery pack ECU executes step-down control for performing step-down at the power converter. The housing B accommodates the high voltage battery, the power converter, and the battery pack ECU. Further, a sensor for detecting at least one of the voltage and temperature of the high voltage battery is provided in the housing B. The battery pack ECU monitors the high voltage battery based on a signal from the sensor and performs step-down control based on the signal from the sensor.

Patent Literature 1 is JP-A-2016-222057, Patent Literature 2 is JP-A-2017-124700, and Patent Literature 3 is JP-A-2017-139138.

### SUMMARY

The inventor assumes that the power supply system for a vehicle as described above is actually configured as in a comparative example illustrated in FIG. 1, for example. The power supply system of FIG. 1 will be described below.

A high voltage battery pack 10 includes a high voltage battery 11 and a high voltage junction block (J/B) 12. The high voltage J/B 12 is connected to the high voltage battery 11 via a high voltage wiring 13 and can distribute the power supply power of the high voltage battery 11 to the two systems of high voltage wirings 14 and 15 and supply them to each of the downstream loads. A high-voltage-based device 31 is connected to the high voltage battery pack 10 via the high voltage wiring 14.

A drive motor module 20 includes a high voltage J/B 21, an inverter 22, a drive motor 23, and a DC/DC converter 24. The high voltage J/B 21 can distribute the high-voltage power supply power supplied from the high voltage battery pack 10 side through the high voltage wiring 15 to two systems of high voltage wirings 25 and 26 and supply them to the downstream sides.

The inverter 22 can convert the DC high-voltage power supply power supplied from the high voltage wiring 25 into three-phase AC power by periodically switching and supply it to the drive motor 23 via the high voltage wiring 27. Therefore, the drive motor 23 can be driven. The drive motor 23 can generate a large torque, and thus the driving force can generate the propulsive force of a vehicle.

The DC/DC converter 24 is an electronic circuit which converts high-voltage DC power supply power supplied through the high voltage wiring 26 into low-voltage DC power supply power such as 12 [V]. The low-voltage DC power supply power generated by the DC/DC converter 24 is supplied to a downstream load via a low voltage wiring 35.

A low voltage J/B 34 provided in the power supply system of FIG. 1 can distribute power in the low-voltage power supply path. That is, the low-voltage DC power output from a 12V battery 33 can be supplied to a 12V-based device 32 via a low voltage wiring 36 and the low voltage J/B 34. And the low-voltage DC power output from the DC/DC converter 24 in the drive motor module 20 can also be supplied to the 12V-based device 32 via the low voltage wiring 35 and the low voltage J/B 34.

It is assumed that the drive motors 23 illustrated in FIG. 1 are usually installed in vicinities of wheels on the front and rear sides of a vehicle body. Therefore, there is a high possibility that a distance between the drive motor module 20 and the high voltage battery pack 10 is relatively long. For example, when supplying low-voltage power supply power from the drive motor module 20 side to the 12V-based device 32 disposed in the passenger compartment, it is inevitable that the wiring length of the low voltage wiring 35 or the low voltage wiring 37 becomes long. Furthermore, since the high voltage wiring 15 needs to allow the power consumed by both the high-voltage and low-voltage loads to pass therethrough, it is inevitable that the thickness and weight of the high voltage wiring 15 increase.

Further, when the distance of the low voltage wirings 35, 36, 37, and the like is increased, the structure of the wire harness including those or the power supply line of the bus bar becomes complicated. Further, in order to avoid that the structure of power supply lines, such as wire harnesses, becomes complicated, it is assumed that the place where the low voltage J/B 34 is arranged is optimized. However, since the drive motor modules 20 exist on the front side and the rear side of the vehicle body, it is difficult to reduce the distance of the low voltage wirings 35, 36, 37, and the like. In other words, the design flexibility may be low in considering the layout of each drive motor module 20, the low voltage J/B 34. 12V-based device 32 in the passenger compartment, and the like.

The invention is made in view of the circumstance described above and an object thereof is to provide a power supply system which can suppress an increase in the length of a power supply line connected to an indoor device (low-voltage-based device such as 12V) while maintaining high design flexibility when examining a layout of a power supply system in a passenger compartment.

In order to achieve the object described above, a power supply system according to the invention is characterized by the following (1) to (12).

(1) A power supply system which includes

a high voltage battery, a high-voltage power distribution unit that distributes high-voltage power supply from the high voltage battery;

a power conversion unit that converts high-voltage power supply supplied from the high-voltage power distribution unit to low-voltage power supply; and

a low-voltage power distribution unit that distributes low-voltage power supply from the power conversion unit, where

the high-voltage power distribution unit branches output into at least two systems and distributes the high-voltage power supply to a drive module for driving a vehicle by power of the high-voltage power supply and to the power conversion unit.

(2) The power supply system according to (1) described above, further including

a second control unit that communicates with a first control unit included in the drive module to control power supply to the drive module.

(3) The power supply system according to (1) or (2) described above, further including

a low voltage battery, where

the low-voltage power distribution unit branches into two systems and low-voltage power supply is supplied from the power conversion unit and the low voltage battery.

(4) The power supply system according to any one of (1) to (3) described above, where

the high-voltage power distribution unit and the drive module that requires power of the high-voltage power supply are connected via a high-voltage cable,

the low-voltage power distribution unit and a low-voltage module including a predetermined load which requires power of the low-voltage power supply are connected via a low-voltage cable, and

the drive module and the low-voltage module are respectively connected to the power supply systems in units of modules.

(5) The power supply system according to (4) described above, where

the high-voltage cable and the low-voltage cable include one power supply line, one ground line, and a communication line.

(6) The power supply system according to (4) or (5) described above, where

the high-voltage cable and the low-voltage cable have different specifications.

(7) The power supply system according to (6) described above, where

a plurality of the drive modules which require power of the high-voltage power supply use the high-voltage cable in common and the low-voltage modules which require power of the low-voltage power supply use the low-voltage cable in common.

(8) The power supply system according to (4) or (5) described above, where

the high-voltage cable and the low-voltage cable are configured of a common electric wire and common connectors are provided at both ends of the electric wire, and

each of the high-voltage power distribution unit and the low-voltage power distribution unit is provided with a common insertion port which is fitted to the connector.

(9) The power supply system according to (4) or (5) described above, where

the high-voltage cable and the low-voltage cable are configured of a common electric wire, one end of the electric wire is extended from the drive module or the low-voltage module, and a common connector is provided at the other end of the electric wire, and

each of the high-voltage power distribution unit and the low-voltage power distribution unit is provided with a common insertion port which is fitted to the connector.

(10) The power supply system according to any one of (1) to (9) described above, where

a plurality of units each including the power conversion unit and the low-voltage power distribution unit are provided.

(11) The power supply system according to any one of (1) to (10) described above, further including

a power supply circuit which converts direct current to alternating current, where

the power supply circuit converts the high-voltage power supply supplied from the high-voltage power distribution unit into alternating current and supplies the alternating current to the drive module.

(12) The power supply system according to any one of (1) to (11) described above, further including

a non-contact charging unit.

According to the power supply system having the configuration of (1) described above, the position of the low-voltage power distribution unit can be determined regardless of the drive motor module 20 or the like which has some restrictions on the position on a vehicle where the module is arranged. Therefore, a highly versatile power supply system can be realized. Further, it is possible to individually determine the connection layout of the power supply lines for the high voltage load and the low voltage load with reference to the position of the high voltage battery pack having the high voltage battery built therein. Further, for example, the power supply power supplied to the drive module by the high-voltage power distribution unit does not include the power consumed by the load on the low voltage side, so that the thickness and weight of the high voltage wiring 15 in FIG. 1 can be reduced.

According to the power supply system having the configuration of (2) described above, communication can be performed between the second control unit and the first control unit. Therefore, for example, when the second control unit is connected to a high voltage battery pack containing the high voltage battery, the high voltage battery pack can control the power supply state of the drive module. Further, even when various types of drive modules having different specifications are connected as necessary, it is possible to control the power supply state to be appropriate according to the actual specifications. Further, when connecting the various modules to the high voltage battery pack, cooperative control between modules can be implemented by the second control unit.

According to the power supply system having the configuration of (3) described above, the power of the low voltage power supply can be supplied to the low-voltage load by selecting one of the two types of routes as necessary. Therefore, for example, even when a failure or malfunction occurs in the power conversion unit or its upstream side, the low voltage battery can be used as a standby power supply and power supply to the low-voltage load can be continued.

According to the power supply system having the configuration of (4) described above, for example, even when various types of modules are connected to the high voltage battery pack containing the high voltage battery, an appropriate connection can be realized simply by selecting one of the high-voltage cable and the low-voltage cable as necessary. Therefore, the entire connection structure can be simplified.

According to the power supply system having the configuration of (5) described above, the power supply system of the invention can be constructed using the cable having a simple configuration. When the cable with such a simple configuration is adopted, the power supply voltage supplied to various modules from the power supply system in which the power distribution structure is integrated becomes a single voltage corresponding to the module. When a plurality of power supply voltages with different voltage values are required for various modules, the power supply voltages may be distributed within the module.

According to the power supply system having the configuration of (6) described above, by using different specifications for the high-voltage cable and the low-voltage cable, it is possible to combine suitable cables for the drive module which requires the power of the high-voltage power supply and the low-voltage module which requires the power of the low-voltage power supply.

According to the power supply system having the configuration of (7) described above, the product numbers of the high-voltage cables and the low-voltage cables can be reduced while combining suitable cables for the drive module which requires the power of the high-voltage power supply and the low-voltage module which requires the power of the low-voltage power supply.

According to the power supply system having the configuration of (8) described above, for example, even when various types of modules are connected to the high voltage battery pack containing the high voltage battery, each module can be connected by the common connection cable (high-voltage cable, low-voltage cable) using the insertion port. Therefore, the types of connection cables and the number of product numbers can be reduced.

According to the power supply system having the configuration of (9) described above, by simply connecting the common connector of the high-voltage cable or the low-voltage cable to the common insertion port, either the high-voltage power distribution unit or the low-voltage power distribution unit can be connected to the drive module or the low-voltage module.

According to the power supply system having the configuration of (10) described above, any one of the plurality of units can be selected as necessary and power supply power can be supplied from the selected unit to the low-voltage load. For example, in a case where the plurality of units are arranged in front and rear separated portions of the vehicle body, the load on the front side can be connected to the front unit close to that position and the load on the rear side can be connected to the rear unit close to that position, so that the length of the cable used for those connections can be shortened.

According to the power supply system having the configuration of (11) described above, since the power supply circuit generates high-voltage AC power, it is easy to control the electric motor which drives the vehicle. For example, when the high voltage battery pack containing the high voltage battery is integrated with the power supply circuit, it becomes easy to cover the whole with the metal cover or the like, and thus it is possible to suppress the noise generated due to the switching of the power supply circuit from affecting the low-voltage load.

According to the power supply system having the configuration of (12) described above, for example, the high voltage battery can be charged using the non-contact charging unit without any operation by a human in a predetermined parking lot or charging station. Therefore, there is no danger of an electric shock during charging and a troublesome charging operation is not required.

According to the power supply system of the invention, while maintaining a high design flexibility when examining a layout of the power supply system in a vehicle compartment, it is possible to suppress an increase in the length of the power supply line connected to the indoor device (low-voltage-based device such as 12V).

Hereinbefore, the invention has been briefly described. Further, the details of the invention will be further clarified by reading through a mode (hereinafter referred to as “embodiment”) for carrying out the invention described below with reference to the accompanying drawings.

### BRIEF DESCRIPTION OF DRAWINGS

FIG. 1 is a block diagram illustrating a configuration of a power supply system of a comparative example.

FIG. 2 is a block diagram illustrating a configuration example of a power supply system according to an embodiment 1.

FIG. 3 is a block diagram illustrating a configuration example of the power supply system according to an embodiment 2.

FIG. 4 is a block diagram illustrating a configuration example of the power supply system according to an embodiment 3.

FIG. 5 is a block diagram illustrating a configuration example of the power supply system according to an embodiment 4 and illustrates a layout of each component viewed from the side.

FIG. 6 is a block diagram illustrating the configuration example of the power supply system according to the embodiment 4 and illustrates a layout of each component on a plane.

FIG. 7 is a block diagram illustrating a configuration example of the power supply system according to an embodiment 5.

FIG. 8A is a block diagram illustrating a configuration example of the power supply system of an embodiment 6, FIG. 8B is a perspective view illustrating a configuration example of a common cable end portion, and FIG. 8C is a longitudinal cross-sectional view which illustrates a configuration example in a cross section of a common cable.

FIG. 9 is a block diagram illustrating a configuration example of the power supply system according to an embodiment 7.

FIG. 10 is a block diagram illustrating a configuration example of the power supply system according to an embodiment 8 and illustrates a layout of each component on a plane.

FIG. 11 is a block diagram illustrating a configuration example of the power supply system according to an embodiment 9 and illustrates a layout of each component in a plane.

FIG. 12 is a block diagram illustrating a configuration example of the power supply system of an embodiment 10 and illustrates a layout of each component viewed from the side.

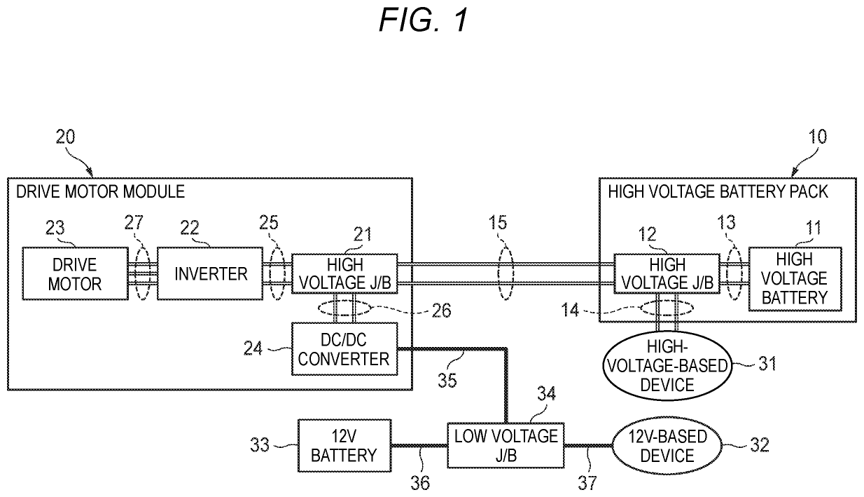

### DESCRIPTION OF EMBODIMENTS

Specific embodiments relating to the invention will be described below with reference to the drawings.

### First Embodiment

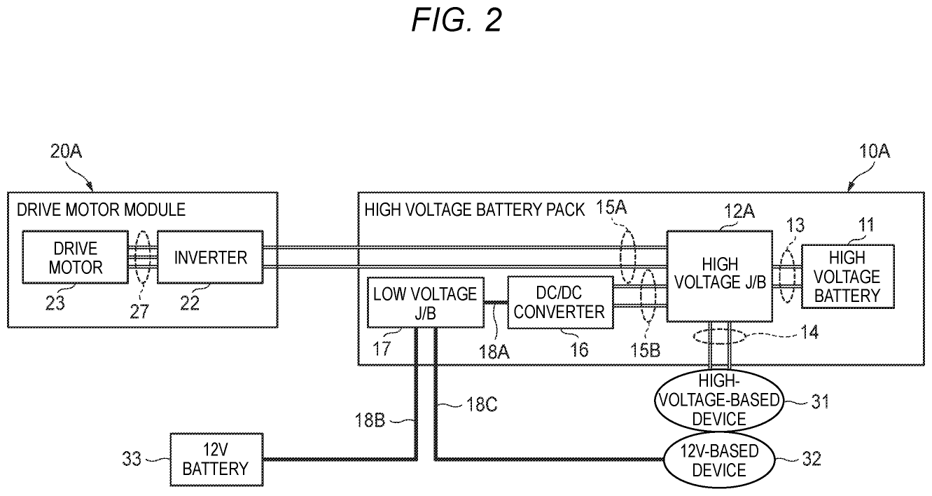

A configuration example of a power supply system of a first embodiment is illustrated in FIG. 2. The power supply system illustrated in FIG. 2 is configured on the assumption that, for example, in a hybrid vehicle or an electric vehicle, the power supply power required by each device on the vehicle is supplied.

The power supply system illustrated in FIG. 2 is configured to distribute the power supply power from a high voltage battery pack 10A as a starting point and to supply the power supply necessary for various on-vehicle devices (loads) around the system. That is, the power supply distribution structure is arranged so as to be concentrated in the high voltage battery pack 10A.

As illustrated in FIG. 2, the high voltage battery pack 10A includes a high voltage battery 11, a high voltage junction block (J/B) 12A, a DC/DC converter 16, and a low voltage J/B 17. The DC voltage handled by the high voltage battery 11 is, for example, about 200 [V].

Each terminal (electrode) of the high voltage battery 11 is connected to the high voltage J/B 12A via a high voltage wiring 13 which is a power supply line. The high voltage J/B 12A branches the power supply path of the high-voltage wiring 13 and can supply the distributed high-voltage power supply power to, for example, three sets of high voltage wirings 15A, 15B, and 14, respectively. Needless to say, when the regenerative power is supplied from the high voltage wiring 15A side, the high voltage J/B 12A can supply the regenerative power to the high voltage wiring 13 and charge the high voltage battery 11.

The high voltage side power supply input of the DC/DC converter 16 in the high voltage battery pack 10A is connected to the high voltage J/B 12A through the high voltage wiring 15B. The DC/DC converter 16 can convert the voltage of the high-voltage DC power supply power supplied from the high voltage wiring 15B to generate, for example, low voltage DC power of 12 [V]. The low voltage DC power output from the DC/DC converter 16 is supplied to the low voltage J/B 17 via a low voltage wiring 18A.

Each power supply terminal of the low voltage J/B 17 is connected to low voltage wirings 18A, 18B, and 18C. The low voltage wiring 18B has one end connected to a 12V battery 33 and the other end connected to the low voltage J/B 17 in the high voltage battery pack 10A. The low voltage wiring 18C has one end connected to the low voltage J/B 17 in the high voltage battery pack 10A and the other end connected to a 12V-based device 32. The low voltage wirings 18A. 18B, and 18C are electrically connected to one another inside the low voltage J/B 17. Accordingly, the low voltage J/B 17 can distribute the low voltage DC power supply power supplied from the low voltage wiring 18A to a plurality of paths and supply it to the low voltage wirings 18B and 18C. Further, the low voltage J/B 17 can also supply the low voltage DC power supplied from the low voltage wiring 18B to the low voltage wiring 18C.

The high-voltage-based device 31 is connected to the high voltage J/B 12A through the high voltage wiring 14. The 12V-based device 32 is connected to the low voltage J/B 17 through the low voltage wiring 18C.

A drive motor module 20A is connected to the high voltage battery pack 10A through the high voltage wiring 15A. In an example of FIG. 2, the drive motor module 20A includes an inverter 22 and a drive motor 23. The inverter 22 can generate three-phase AC power by periodically switching high-voltage DC power supply power supplied from the high voltage battery pack 10A to the high voltage wiring 15A. The AC power generated by the inverter 22 is supplied to the drive motor 23 via the high voltage wiring 27.

The drive motor 23 is a main drive source for generating the propulsive force of a vehicle or generates an auxiliary drive force. When independent drive motors 23 are prepared for the respective wheels of the vehicle, it is assumed that four wheels are arranged at positions away from each other, so that an independent drive motor module 20A is prepared for each wheel. Alternatively, it is assumed that independent drive motor modules 20A are respectively arranged on the front side and the rear side of a vehicle body.

In any case, in the configuration of FIG. 2, the power supply power necessary for driving each drive motor 23 can be obtained by simply connecting the drive motor module 20A to the high voltage battery pack 10A with a cable of the high voltage wiring 15A for each module. Further, since the high voltage wiring 15A allows only the high-voltage power consumed inside the drive motor module 20A to pass therethrough, it is possible to avoid an increase in the thickness of the connection cable.

Also, the power supply connection points are concentrated in the high voltage battery pack 10A. Therefore, not only the drive motor module 20A but also any of the 12V battery 33, 12V-based device 32, and high-voltage-based device 31 can be configured to form the system by simply connecting each to the high voltage battery pack 10A via the connection cables (13B, 18C. 14). In other words, since various modules can be connected to the high voltage battery pack 10A via the connection cable, it is highly versatile and it becomes easy to increase or decrease the number of modules or change the type of modules to be connected as necessary.

Regarding the power supply lines such as the high voltage wirings 15A and 14 and the low voltage wirings 18B and 18C connected to the high voltage battery pack 10A illustrated in FIG. 2, it may be prepared as independent connection cables, incorporated in a wire harness, or configured as bus bars.

### Second Embodiment

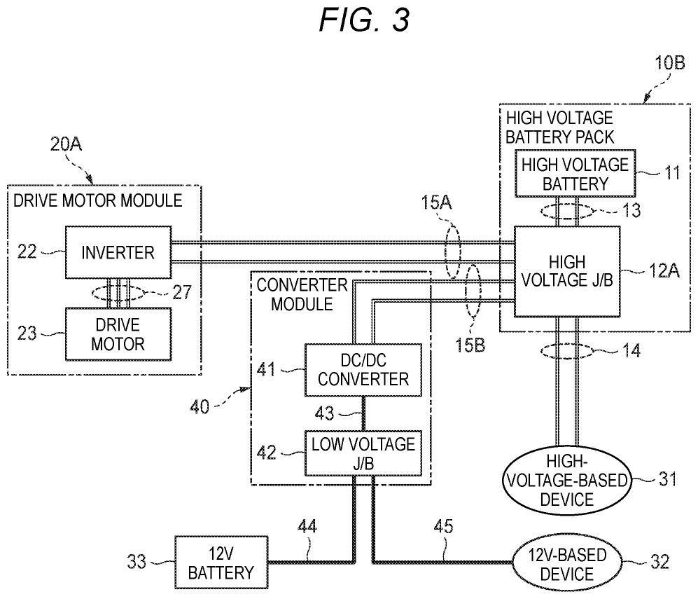

The configuration of the power supply system of a second embodiment is illustrated in FIG. 3. The power supply system illustrated in FIG. 3 is a modification example with the configuration of FIG. 2. Matters that differ from those of the configuration of FIG. 2 will be described below.

In the power supply system of FIG. 3, a converter module 40 including the DC/DC converter 41 and the low voltage J/B 42 is provided as an independent module and the converter module 40 is disposed outside the high voltage battery pack 10B.

The power supply input terminal of the DC/DC converter 41 in the converter module 40 is connected to the high voltage battery pack 10B through the high voltage wiring 15B. Three low voltage wirings 43, 44, and 45 are connected to the low voltage J/B 42 in the converter module 40. The low voltage J/B 42 can receive the low-voltage power supply power output from the DC/DC converter 41 from the low voltage wiring 43, distribute the power, and supply it to the low voltage wirings 44 and 45, respectively. Further, the low voltage J/B 42 can receive the low-voltage power supplied from the 12V battery 33 from the low voltage wiring 44 and supply it to the low voltage wiring 45.

### Third Embodiment

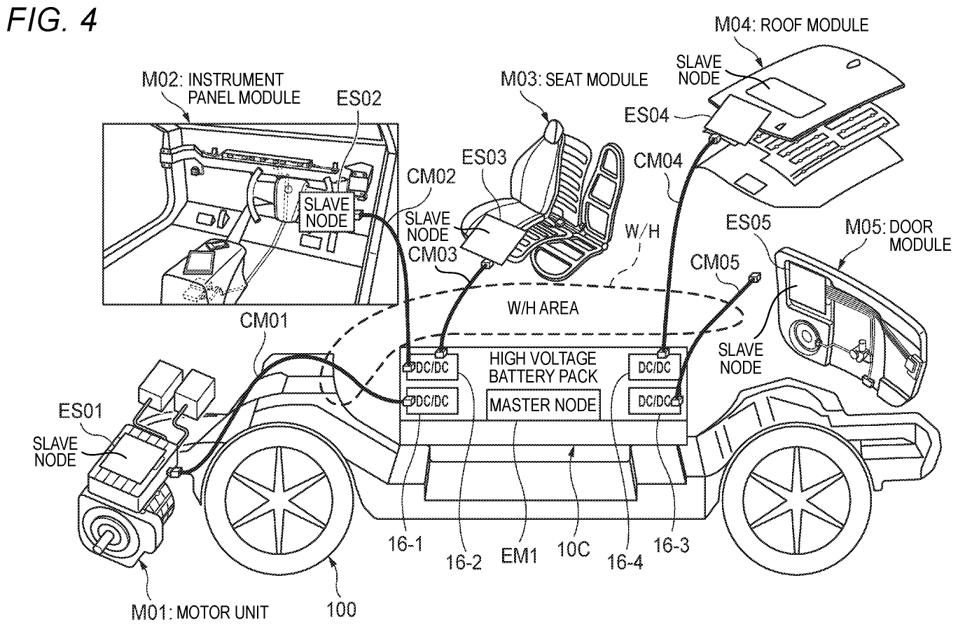

A configuration example of the power supply system of a third embodiment is illustrated in FIG. 4.

The power supply system illustrated in FIG. 4 includes the high voltage battery pack 10C and various modules M01 to M05 connected to the high voltage battery pack 10C. The high voltage battery pack 10C is disposed at substantially the center of a vehicle body 100, that is, at the lower part of the region corresponding to a passenger compartment, and is formed in a box shape having a planar shape with the same size as the passenger compartment. The modules M01 to M05 are arranged at positions close to any of the front side, lateral side, rear side, and upper side of the high voltage battery pack 10C.

The module M01 is a drive motor module (or a motor unit) including the drive motor 23 which generates the driving force for the vehicle. The module M02 is an instrument panel module including a meter unit arranged in an instrument panel area of the vehicle body 100. The module M03 is a seat module arranged in a seat area in the passenger compartment. The module M04 is a roof module arranged in a roof area above the passenger compartment. The module M05 is a door module arranged in the area of each door.

The basic configuration of the high voltage battery pack 10C is the same as that of the high voltage battery pack 10A illustrated in FIG. 2, but a master electronic control unit (ECU) EMI is further provided in the high voltage battery pack 10C to enable control of the power supply system. The master ECU EMI functions as a master node in the communication network of the power system on the vehicle and can control each slave node under its control by communication. The high voltage battery pack 10C illustrated in FIG. 4 includes four independent DC/DC converters 16-1 to 16-4.

Further, as illustrated in FIG. 4, the modules M01, M02, M03, M04, and M05 are respectively equipped with slave ECUs ES01, ES02. ES03, ES04, and ES05. Each of the slave ECUs ES01 to ES05 functions as a slave node in the communication network of the power supply system on the vehicle.

The module M01 is connected to the high voltage battery pack 10C via a module cable CM01. The module M02 is connected to the high voltage battery pack 10C via a module cable CM02. The module M03 is connected to the high voltage battery pack 10C via a module cable CM03. The module M04 is connected to the high voltage battery pack 10C via a module cable CM04. The module M05 is connected to the high voltage battery pack 10C via a module cable CM05.

Each of the module cables CM01 to CM05 incorporates two communication lines in addition to the power supply line and the ground line. That is, the master ECU EMI in the high voltage battery pack 10C and each of the slave ECUs ES01 to ES05 in each of the modules M01 to M05 are connected to the same network via the communication lines in the module cables CM01 to CM05 so that they can communicate with each other.

The master ECU EMI in the high voltage battery pack 10C can perform various cooperative controls by communicating with the slave ECUs ES01 to ES05 in each of the modules M01 to M05. For example, even when the type and specification of a module connected to each position of the high voltage battery pack 10C is not set in advance or a newly created module is added, the master ECU EMI can send an appropriate control signal to each slave node so as to grasp the type and specification of the corresponding module and supply the appropriate power supply power.

In addition, regarding the master ECU EM1 which has a control function of the high voltage battery pack 10C, the following connection forms other than being incorporated in the high voltage battery pack 10C are also considered. (1) A slot capable of accommodating the master ECU EMI is mounted on the high voltage battery pack 10C. Only in a case of specifications that require the communication function of the power supply system, a circuit board or the like of the master ECU EMI is inserted into the slot of the high voltage battery pack 10C, in such a manner that the communication function and the control function are added. (2) The circuit board of the master ECU EMI is prepared as one independent module and this module is connected to the high voltage battery pack 10C using a wire harness WH or the like as necessary. This module may be installed in a connector of the wire harness WH.

Further, each of the slave ECUs ES01 to ES05 may be mounted in, for example, connectors in the end portions of the module cables CM01 to CM05 or a circuit board disposed in the connector of the wire harness WH other than that.

### Fourth Embodiment

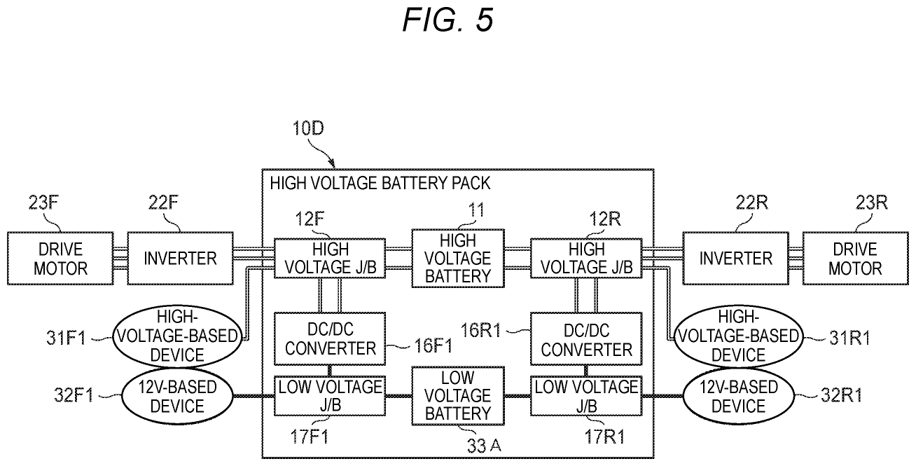

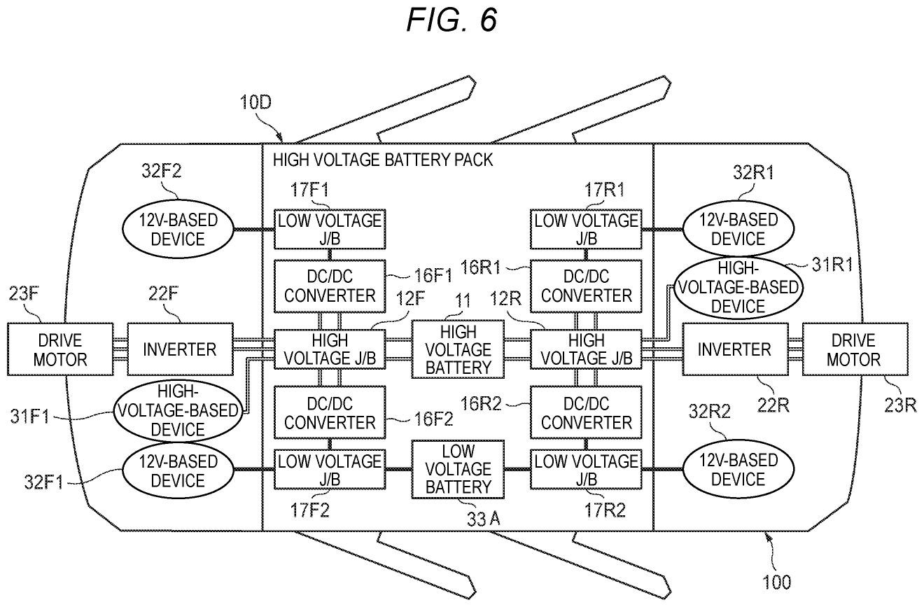

FIG. 5 and FIG. 6 illustrate a configuration example of the power supply system of a fourth embodiment. FIG. 5 illustrates a layout of each component viewed from the side of the vehicle and FIG. 6 illustrates the layout of each component on the plane. In FIGS. 5 and 6, the left side in the drawing represents the front side of the vehicle body 100 and the right side represents the rear side.

The power supply system illustrated in FIGS. 5 and 6 is configured around a high voltage battery pack 10D disposed in the central portion of the vehicle body 100, that is, in a region corresponding to the passenger compartment. The high voltage battery pack 10D 25 includes the high voltage battery 11, a low voltage battery 33A, high voltage J/Bs 12F and 12R, DC/DC converters 16F1, 16F2, 16R1, and 16R2, and low voltage J/Bs 17F1, 17F2, 17R1, and 17R2.

As illustrated in FIG. 6, the high voltage J/B 12F is arranged on the front side of the vehicle body 100 and the high voltage J/B 12R is arranged on the rear side. The DC/DC converter 16F1 and the low voltage J/B17F1 are arranged on the front right side and the DC/DC converter 16F2 and the low voltage J/B 17F2 are arranged on the front left side. Further, the DC/DC converter 16R1 and the low voltage J/B 17R1 are arranged on the rear right side and the DC/DC converter 16R2 and the low voltage J/B 17R2 are arranged on the rear left side.

The low voltage battery 33A can supply, for example, 12 [V] low voltage DC power supply power. In the power supply system illustrated in FIGS. 5 and 6, it is assumed that the low voltage battery 33A is used as standby power supply. That is, when failure occurs in the low-voltage power supply from the high voltage battery 11 side, the standby power of the low voltage battery 33A is supplied to each load of the low voltage system. The low voltage battery 33A may be disposed outside the high voltage battery pack 10D and connected with the high voltage battery pack 10D by a cable or the like.

The high voltage J/B 12F on the front side can distribute the high-voltage power supplied from the high voltage battery 11 to four pieces of power and supply them to the DC/DC converters 16F1 and 16F2, the inverter 22F, and the high-voltage-based device 31F1. The inverter 22F can switch the high-voltage DC power supplied from the high voltage J/B 12F to generate three-phase AC power and supply it to the drive motor 23F. The drive motor 23F is configured as, for example, two in-wheel motors disposed on the left and right wheels on the front side.

The high voltage J/B 12R on the rear side can distribute the high-voltage power supplied from the high voltage battery 11 to four pieces of power and supply them to the DC/DC converters 16R1 and 16R2, the inverter 22R, and the high-voltage-based device 31R1. The inverter 22R can switch the high-voltage DC power supplied from the high voltage J/B 12R to generate three-phase AC power and supply it to the drive motor 23R. The drive motor 23R is configured as, for example, two in-wheel motors disposed on the left and right wheels on the rear side.

The low voltage J/B 17F1 on the front right side can supply the low-voltage (12[V] or the like.) DC power supply power output from the DC/DC converter 16F1 to the 12V-based device 32F2 or the like. The low voltage J/B 17R on the rear right side can supply the low-voltage DC power output from the DC/DC converter 16R1 to the 12V-based device 32R1 or the like.

The low voltage J/B 17F2 on the front left side can supply at least one of the low-voltage DC power supply power output from the DC/DC converter 16F2 and the DC power of the low voltage battery 33A, which is the standby power supply, to the 12V-based device 32F2. For example, in a normal state, power supply power is supplied from the output of the DC/DC converter 16F2 to the 12V-based device 32F2 or the like and, when failure occurs, power supply power is supplied from the output of the low voltage battery 33A to the 12V-based device 32F2 or the like.

Similarly the low voltage J/B 17R on the rear right side can supply at least one of the low-voltage DC power supply power output from the DC/DC converter 16R1 and the DC power supply power of the low voltage battery 33A, which is the standby power supply, to the 12V-based device 32R1 or the like.

The output of the low voltage battery 33A may be connected to each of the low voltage J/Bs 17F1 and 17R1 on the right side.

That is, in the power supply system illustrated in FIGS. 5 and 6, the standby power supply power of the low voltage battery 33A can be used even when malfunction or failure occurs in the high voltage battery 11 or the like. Therefore, necessary power can be supplied to at least part of the 12V-based devices 32F1, 32F2, 32R1, and 32R2.

### Fifth Embodiment

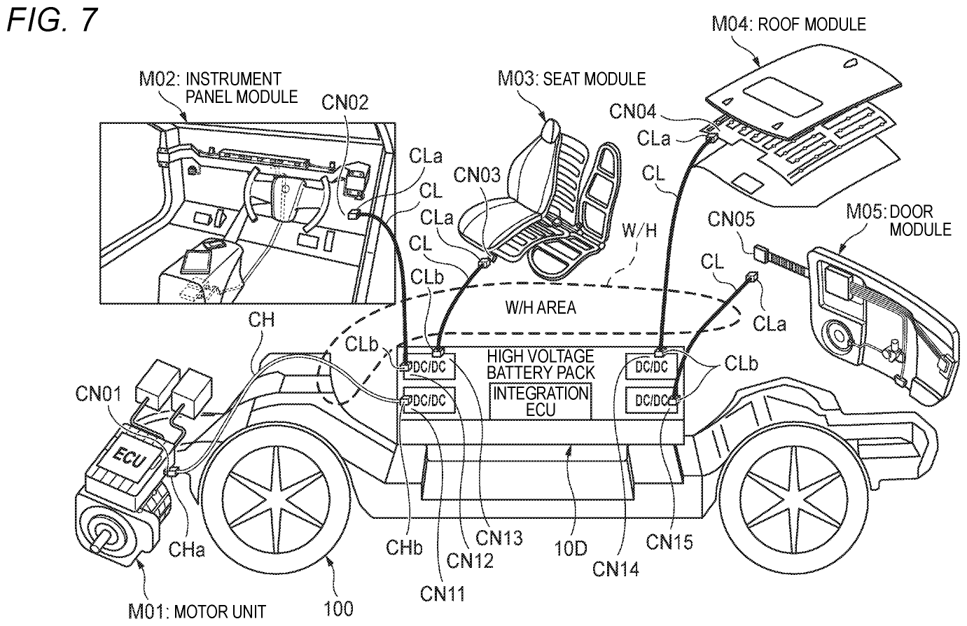

A configuration example of the power supply system of a fifth embodiment is illustrated in FIG. 7.

The power supply system illustrated in FIG. 7 includes the high voltage battery pack 10D and various modules M01 to M05 connected to the high voltage battery pack 10D. The high voltage battery pack 10D is disposed in the approximate center of the vehicle body 100, that is, in the lower part of the region corresponding to the vehicle compartment, and is formed in a box shape having a planar shape that is the same size as the vehicle compartment. The modules M01 to M05 are arranged at positions close to any of the front side, lateral side, rear side, and upper side of the high voltage battery pack 10D.

The basic configuration of each of the modules M01 to M05 is the same as the configuration in FIG. 4.

In the configuration of FIG. 7, the module M01 which requires high-voltage power supply power and the high voltage battery pack 10D are connected to each other via a high-voltage cable CH. The modules M02 to M05 which require low-voltage power supply power and the high voltage battery pack 10D are connected to each other via low-voltage cables CL.

That is, in this example, two types of cables are prepared in advance to connect between each module and the high voltage battery pack 10D. Each of the high-voltage cable CH and the low-voltage cables CL includes one power supply line, one ground line, and two communication lines. Thus, when adopting a cable with a simple configuration of one power line and one ground line, the power supply voltage supplied to the modules M02 to M05 from the high voltage battery pack 10D in which the power distribution structure is integrated becomes a single voltage corresponding to the modules M02 to M05. When a plurality of power supply voltages having different voltage values are required for each of the modules M02 to M05, the power supply voltage may be distributed within the module. For example, two twisted electric wires are used as the two communication lines. Connectors CHa and CHb are respectively provided at both end portions of the high-voltage cable CH. In addition, connectors CLa and CLb are respectively provided at both end portions of the low-voltage cable CL. In addition, in this embodiment, although the communication line is configured of the electric wire in which two electric wires form one set (a pair) of electric wires, it may be configured of the electric wire which is formed of a plurality of sets (a plurality of pairs) equal to or larger than two sets (two pairs). Further, the communication line is not limited to an electric wire and may be an optical cable.

Since the high-voltage cable CH needs to handle a high voltage, it has a higher electrical insulation performance than, for example, the low-voltage cable CL. In addition, in order to facilitate the proper use of different types of high-voltage cables CH and low-voltage cables CL, connectors CHa and CHb of the high-voltage cable CH and connectors CLa and CLb of the low-voltage cable CL have slightly different shapes.

The high voltage battery pack 10D includes, for example, a connector CN11 connected to an output corresponding to the high voltage J/B 12A illustrated in FIG. 2. The connector CN11 has an insertion port with a shape which can be fitted to the connector CHb of the high-voltage cable CH. The module M01 includes a connector CN01 connected to an internal high-voltage circuit. The connector CN01 has an insertion port with a shape which can be fitted to the connector CHa of the high-voltage cable CH. The connectors CHa and CHb of the high-voltage cable CH may have a common shape. Further, the connector CN11 of the high voltage battery pack 10D and the connector CN01 of the module M01 may have a common shape. Thereby, when the high-voltage cable CH with one specification is prepared, it is possible to connect the high voltage battery pack 10D and a plurality of types of modules M01 driven by the high voltage. As a result, the product number of the high-voltage cable CH can be suppressed.

Further, the high voltage battery pack 10 OD includes a plurality of connectors CN12 to CN15 connected to a portion corresponding to the low voltage output of the low voltage J/B 17 illustrated in FIG. 2, for example. Further, those connectors CN12 to CN15 are arranged at positions separated from each other such as front, rear, left, and right end portions of the high voltage battery pack 10D. The connectors CN12 to CN15 have an insertion port with a shape which can be fitted to the connector CLb of the low-voltage cable CL.

Each of the modules M02 to M05 which require low-voltage power supply power includes connectors CN02 to CN05 connected to an internal low-voltage circuit. The connectors CN02 to CN05 have an insertion port with a shape which can be fitted to the connector CLa of the low-voltage cable CL. The connectors CLa and CLb of the low-voltage cable CL may have a common shape. Further, the connectors CN12 to CN15 of the high voltage battery pack 10D and the connectors CN02 to CN05 of the modules M02 to M05 may have a common shape. Accordingly, when the low-voltage cables CL with one specification is prepared, it is possible to connect the high voltage battery pack 10D and a plurality of types of modules M02 to M05 driven by the low voltage. Thereby, the product number of the low-voltage cables CL can be suppressed.

Regarding the high-voltage cable CH and the low-voltage cables CL connecting the high voltage battery pack 10D and each of the modules M01 to M05, they may be incorporated in the wire harness WH as a part thereof, prepared separately from the wire harness WH as independent cables, or configured as bus bars.

The high voltage battery pack 10D and each of the modules M01 to M05 illustrated in FIG. 7 are each equipped with a control unit (ECU) having a communication function and a control function. However, those control units may be arranged in the wire harness WH or on circuit boards built in connectors of the high-voltage cable CH or the low-voltage cables CL.

In the power supply system illustrated in FIG. 7, the product number of parts used in the wire harness WH and the like can be reduced because only two types of cables, that is, the high-voltage cable CH and the low-voltage cable CL, are used for connecting the power supply. In addition, it is possible to prevent a connection error between the high voltage system and the low voltage system.

### Sixth Embodiment

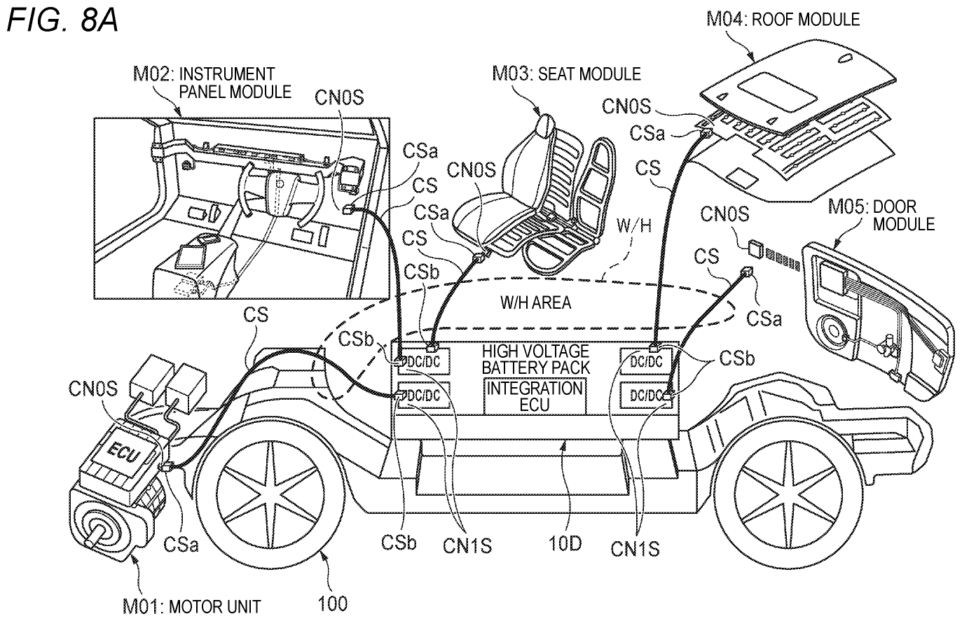

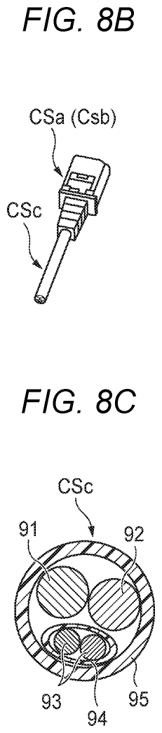

A configuration example of the power supply system of a sixth embodiment is illustrated in FIG. 8A. Further, FIG. 8B illustrates a configuration example of the common cable end portion and FIG. 8C illustrates a configuration example in a cross section of the common cable.

The power supply system illustrated in FIG. 8A includes a high voltage battery pack 10D and various modules M01 to M05 connected to the high voltage battery pack 10D. The high voltage battery pack 10D is disposed in the approximate center of the vehicle body 100, that is, in the lower part of the region corresponding to the vehicle compartment, and is formed in a box shape having a planar shape which is the same size as the vehicle compartment. The modules M01 to M05 are arranged at positions close to any of the front side, lateral side, rear side, and upper side of the high voltage battery pack 10D.

The basic configuration of each of the modules M01 to M05 is the same as the configuration in FIG. 4.

In the configuration of FIG. 8A, regardless of the difference between the high voltage system and the low voltage system, each of the modules M01 to M05 which requires power supply power and the high voltage battery pack 10D are connected to each other via common cables CS. As illustrated in FIG. 8C, this common cable CS includes one power line 91, one ground line 92, two signal lines 93, and a sheath/braided layer 94 covering the two signal lines and the outer sides of the power supply line 91, the ground line 92, the signal lines 93, and the sheath/braided layer 94 are covered with an exterior material 95. Thus, when adopting a cable having a simple configuration of one power line 91 and one ground line 92, the power supply voltage supplied to each of the modules M01 to M05 from the high voltage battery pack 10D in which the power distribution structure is integrated becomes a single voltage corresponding to each of the modules M01 to M05. When a plurality of power supply voltages having different voltage values are required in each of the modules M01 to M05, the power supply voltage may be distributed within the particular module M01 to M05. In addition, in this embodiment, although the communication line is configured of the electric wire in which two electric wires form one set (a pair) of electric wires, it may be configured of the electric wire which is formed of a plurality of sets (a plurality of pairs) equal to or larger than two sets (two pairs). Further, the communication line is not limited to an electric wire and may be an optical cable.

That is, in this example, the high voltage battery pack 10D and each of the modules M01 to M05 are connected using the common cables CS having specifications which can be used for both the high voltage system and the low voltage system. Moreover, as illustrated in FIG. 8B, each common cable CS has an electric wire CSc and common connectors CSa and CSb connected to the both end portions. The electric wire CSc includes a power supply line 91, a ground line 92, signal lines 93, and a sheath/braided layer 94.

The high voltage battery pack 10D includes, for example, a plurality of common connectors CN1S connected to locations corresponding to outputs of the high voltage J/B 12A or the low voltage J/B 17 illustrated in FIG. 2. Those common connectors CN1S have insertion ports which can be fitted to common connectors CSb of the common cables CS. Each of the modules M01 to M05 is provided with a common connector CN0S connected to its internal power supply line. The common connector CN0S has an insertion port with a shape which can be fitted to the common connector CSa of the common cable CS.

The common connectors CSa and CSb of the common cable CS may have a common shape. Further, the common connector CN1S of the high voltage battery pack 10D and the common cable CS0S of each of the modules M01 to M05 may have a common shape. Further, for example, among the plurality of pins included in the common connector CN1S, the pin connected to a high-voltage circuit and the pin connected to a low-voltage circuit are assigned to be in different positions. Thereby, even when the common cable CS is used, it is possible to prevent erroneous connection between the high voltage circuit and the low voltage circuit.

Regarding the common cables CS connecting the high voltage battery pack 10D and each of the modules M01 to M05, they may be incorporated in the wire harness WH as a part thereof, prepared separately from the wire harness WH as independent cables, or configured as bus bars.

The high voltage battery pack 10D and each of the modules M01 to M05 illustrated in FIG. 8A are equipped with control units (ECU) having a communication function and a control function. Those control units may be arranged in the wire harness WH or on a circuit board built in each connector of the common cables CS.

In the power supply system illustrated in FIG. 8A, the high voltage battery pack 10D and each of the modules M01 to M05 can be connected using the common cable CS of which the connector shape and the structure are standardized. Therefore, the types of parts and the product number of parts can be reduced, and thus management and cost of parts can be reduced.

For type differences and specification changes of the modules M01 to M05 which are actually connected to the high voltage battery pack 10D, it is possible to supply power in a state that matches the actual type and specifications by making the control unit on the high voltage battery pack 10D side communicate with the control units on each of the modules M01 to M05 sides. A function for identifying the difference between the types of modules as described above and performing signal conversion according to the difference in specifications may be provided on a circuit board disposed in each connector. This facilitates the common use of the connection cable.

### Seventh Embodiment

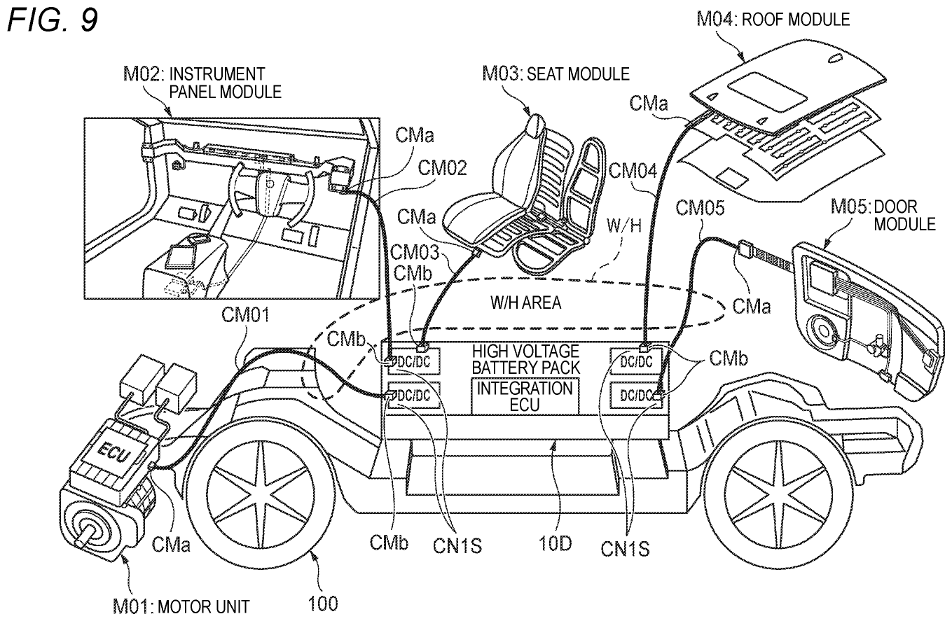

A configuration example of the power supply system of a seventh embodiment is illustrated in FIG. 9.

The power supply system illustrated in FIG. 9 includes the high voltage battery pack 10D and various modules M01 to M05 connected to the high voltage battery pack 10D. The configuration of the high voltage battery pack 10D in FIG. 9 is the same as that in FIG. 8A. The basic configuration of each of the modules M01 to M05 is the same as that illustrated in FIG. 4.

In the configuration of FIG. 9, a cable end portion CMa of a module cable CM01 is fixed in advance to the module M01 and the module M01 and the module cable CM01 are integrated. A connector CMb is attached to an end portion of the module cable CM01 opposite to the cable end portion CMa. The connector CMb is formed in a shape which can be fitted to common connectors CN1S of the high voltage battery pack 10D.

Similarly, cable end portions CMa of the module cables CM02 to CM05 are respectively fixed to the modules M02 to M05. That is, the module cables CM02 to CM05 are respectively integrated with the modules M02 to M05. Each connector CMb attached to each end of the module cables CM02 to CM05 is formed in a shape which can be fitted to the common connectors CN1S of the high voltage battery pack 10D.

Therefore, each of the modules M01 to M05 can be connected to the high voltage battery pack 10D by inserting each connector CMb of the module cables CM01 to CM05 into any common connector CN1S of the high voltage battery pack 10D.

For example, as in the configuration of FIG. 8C, each electric wire of the module cables CM01 to CM05 includes a power supply line 91, a ground line 92, signal lines 93, and a sheath/braided layer 94 and the outer sides thereof are covered with an exterior material 95.

Further, the high voltage battery pack 10D and each of the modules M01 to M05 illustrated in FIG. 9 are equipped with control units (ECUs) having a communication function and a control function. Those control units may be arranged in the wire harness WH or on a circuit board built in each connector CMb of each of the module cables CM01 to CM05.

For type differences and specification changes of the modules M01 to M05 which are actually connected to the high voltage battery pack 10D, it is possible to supply power in a state that matches the actual type and specifications by making the control unit on the high voltage battery pack 10D side communicate with the control units on each of the modules M01 to M05 sides. A function for identifying the difference between the types of modules as described above and performing signal conversion according to the difference in specifications may be provided on a circuit board disposed in each connector. As a result, it becomes easy to connect various types of modules to the high voltage battery pack 10D and it is easy to cope with changes in specifications.

### Eighth Embodiment

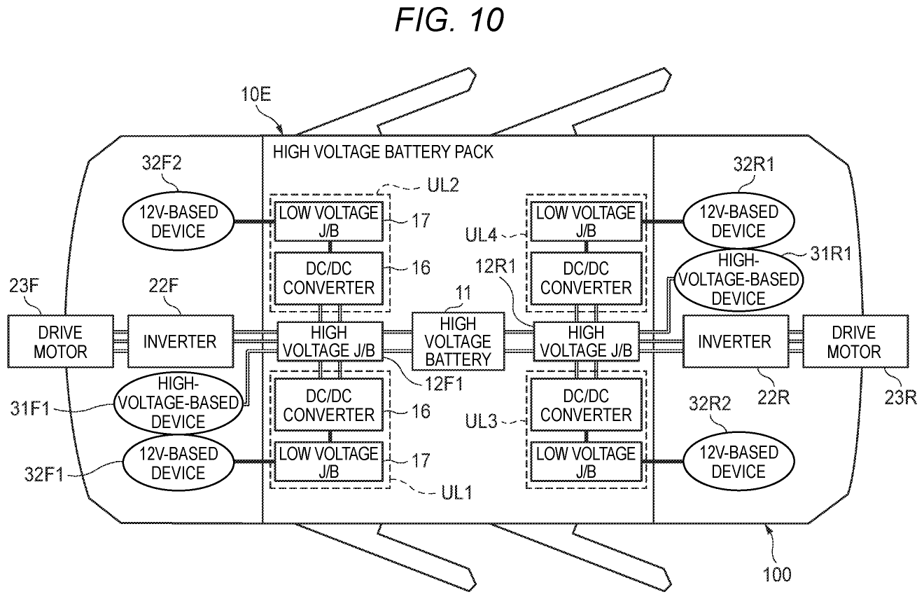

A configuration example of the power supply system of an eighth embodiment is illustrated in FIG. 10. FIG. 10 illustrates a layout of each component in the plane of the vehicle body 100.

The left side in FIG. 10 represents the front side and the right side represents the rear side.

The power supply system illustrated in FIG. 10 is configured around a high voltage battery pack 10E disposed in the central portion of the vehicle body 100, that is, in a region corresponding to a passenger compartment. The high voltage battery pack 10E includes a high voltage battery 11, high voltage J/Bs 12F1 and 12R1, and four low voltage units UL1 to UL4.

Each of the low voltage units UL1 to UL4 is a unit obtained by combining the DC/DC converter 16 and the low voltage J/B 17 described above. In an example of FIG. 10, four low voltage units UL1 to UL4 are arranged in a distributed manner on the front left side, front right side, rear left side, and rear right side in the high voltage battery pack 10E.

In addition, the 12V-based device 32F1 on the front left side of the vehicle body 100 is connected to the low voltage J/B 17 of the low voltage unit UL1 located near the 12V-based device 32F1. Further, the 12V-based device 32F2 on the front right side of the vehicle body 100 is connected to the low voltage J/B 17 of the low voltage unit UL2 located near the 12V-based device 32F2. The 12V-based device 32R2 on the rear left side of the vehicle body 100 is connected to the low voltage J/B 17 of the low voltage unit UL3 located near the 12V-based device 32R2. The 12V-based device 32R1 on the rear right side of the vehicle body 100 is connected to the low voltage J/B 17 of the low voltage unit UL4 located near the 12V-based device 32R1. The configuration other than the above is the same as the configuration illustrated in FIG. 6.

In an example illustrated in FIG. 10, the low voltage units UL1 to UL4 are arranged at the respective positions of the four corners of the high voltage battery pack 10E. However, it is assumed that the layout and the configuration are changed as necessary. For example, two low voltage units UL1 and UL2 may be arranged at positions separated in a front-rear direction of the vehicle body 100. Further, those units may be arranged at positions separated in a right-left direction of the vehicle body 100 or the number of units may be increased to about six.

For example, as illustrated in FIG. 10, when the low voltage units UL1 to UL4 are arranged at the four corners of the high voltage battery pack 10E located at the center of the vehicle body, the 12V-based device 32F1 on the front left side can be connected to the low voltage unit UL1 with a short distance. Similarly, the 12V-based device 32F2 on the front right side can be connected to the low voltage unit UL2 with a short distance. Also, the 12V-based device 32R2 on the rear left side can be connected to the low voltage unit UL3 with a short distance. Furthermore, the 12V-based device 32R1 on the rear right side can be connected to the low voltage unit UL4 with a short distance. Therefore, the length, weight, cost, and the like of the cables and wire harnesses necessary for those connections can be reduced.

### Ninth Embodiment

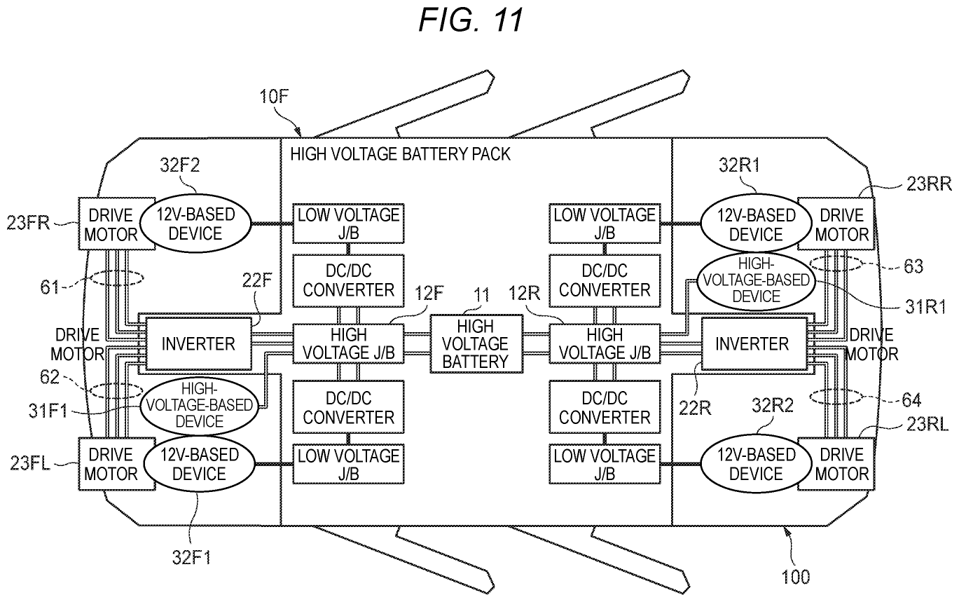

A configuration example of the power supply system of a ninth embodiment is illustrated in FIG. 11. FIG. 11 illustrates a layout of each component in the plane of the vehicle body 100.

The power supply system illustrated in FIG. 11 is configured around a high voltage battery pack 10F disposed in the center of the vehicle body 100, that is, in a region corresponding to a passenger compartment. The high voltage battery pack 10F includes a high voltage battery 11, two high voltage J/Bs 12F and 12R, four DC/DC converters 16, four low voltage J/Bs 17, and two inverters 22F and 22R.

That is, the high voltage battery pack 10F in FIG. 11 is largely different from the configuration in FIG. 6 in that the inverters 22F and 22R are incorporated. The high voltage battery pack 10F is entirely covered with a metal cover or the like. Therefore, electromagnetic noise generated by high voltage and large current switching in the inverters 22F and 22R and noise generated in other high-voltage circuits can be suppressed from being radiated to the outside of the high voltage battery pack 10F by being shielded by the metal cover. Thereby, it is possible to prevent the low-voltage-based electronic device from malfunctioning due to the influence of noise and the noise from being mixed into the output of the in-vehicle audio device.

Moreover, since the inverters 22F and 22R can be installed in the vehicle body 100 together with the high voltage battery pack 10F, the number of work steps for installing the inverters 22F and 22R can be reduced.

In a configuration illustrated in FIG. 11, an inverter 22F arranged on the front side of the vehicle body 100 receives high-voltage DC power supply power distributed by the high voltage J/B 12F and generates three-phase AC power by switching. The inverter 22F is connected to a drive motor 23FL on the front left side and a drive motor 23FR on the front right side via high voltage wirings 61 and 62.

Further, the inverter 22R disposed on the rear side of the vehicle body 100 receives high-voltage DC power supply power distributed by the high voltage J/B 12R, and generates three-phase AC power by switching. The inverter 22R is connected to a drive motor 23RL on the rear left side and a drive motor 23RR on the rear right side via high voltage wirings 63 and 64.

That is, the inverter 22F has the ability to drive the two drive motors 23FL and 23FR on the front side and the inverter 22R has the ability to drive the two drive motors 23RL and 23RR on the rear side.

### Tenth Embodiment

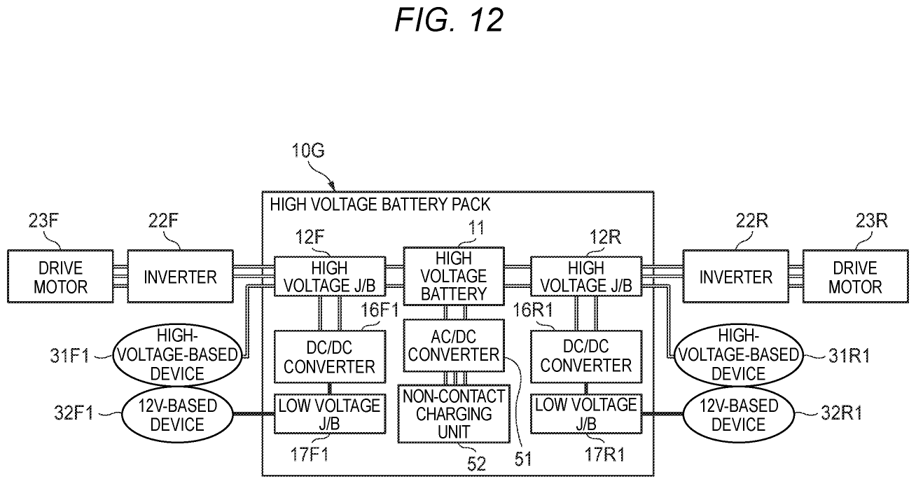

A configuration example of the power supply system of a tenth embodiment is illustrated in FIG. 12. FIG. 12 illustrates a layout of each component viewed from the side of the vehicle body 100. The left side in FIG. 12 represents the front side of the vehicle body 100 and the right side represents the rear side.

The power supply system illustrated in FIG. 12 is configured around a high voltage battery pack 10G arranged in the central portion of the vehicle body 100, that is, in a region corresponding to a passenger compartment. The high voltage battery pack 10G includes a high voltage battery 11, high voltage J/Bs 12F and 12R, DC/DC converters 16F1 and 16R1, low voltage J/Bs 17F1 and 17R1, an AC/DC converter 51, and a non-contact charging unit 52.

That is, the point that the AC/DC converter 51 and the non-contact charging unit 52 are added in FIG. 12 is a large difference from the configuration of FIG. 5. The non-contact charging unit 52 incorporates a power receiving coil disposed horizontally near a bottom surface of the vehicle body 100 facing the road surface and an electric circuit (such as a resonance circuit) for efficiently extracting power from this coil.

For example, a power transmission coil (not illustrated) is installed in the road surface where the vehicle is parked and predetermined AC power is supplied to the power transmission coil from ground power supply during charging. The vehicle to be charged is parked in a state where the power receiving coil of the non-contact charging unit 52 mounted on the vehicle body 100 is positioned so as to face the ground power transmitting coil with a relatively short distance. When AC power is supplied to the power transmission coil, a magnetic resonance phenomenon occurs between the power transmission coil and the power receiving coil and the AC power of the power transmission coil is efficiently transmitted to the power receiving coil in a non-contact manner.

The AC power received by the power receiving coil of the non-contact charging unit 52 is output from the non-contact charging unit 52 and converted into DC power by the AC/DC converter 51. Then, the high voltage battery 11 is charged by the high-voltage DC power output from the AC/DC converter 51.

As illustrated in FIG. 12, by incorporating the non-contact charging unit 52 in the high voltage battery pack 10G, the power receiving coil in the non-contact charging unit 52 can be easily positioned with respect to the vehicle body. As a result, the number of work steps for installation can be reduced.

In addition, in order for the magnetic field generated by the ground power transmission coil to reach the power receiving coil in the non-contact charging unit 52 efficiently, the metal cover which covers the entire high voltage battery pack 10G need to be made of a nonmagnetic material such as copper, aluminum, and stainless steel. Further, it is necessary to electrically insulate between the metal cover and the power receiving coil.

<Advantages of Power Supply System of Each Embodiment>

For example, as in the embodiment illustrated in FIG. 3, the power consumed by the high-voltage-based drive motor module 20A and the power consumed by the low-voltage-based load are respectively distributed by the high voltage J/B 12A in the high voltage battery pack 10B. As a result, it is possible to increase design flexibility in the layout in which each module, the low voltage J/B, the 12V-based device 32 in the passenger compartment and the like are arranged. That is, the main body of the power supply function can be concentrated in the high voltage battery pack 10B and the power can be distributed separately from the high voltage battery pack 10B for each system.

For example, since the high voltage wiring 15A distributes only the high-voltage power consumed by the drive motor module 20A, it is possible to avoid an increase in the thickness of the electric wire. Moreover, when considering the wiring path and length of the high voltage wiring 15A, there is no need to consider the distribution path of the power consumed by the 12V-based device 32 or the like, which is a low-voltage-based device, and the positional relationship with other modules. As a result, design flexibility is increased.

In addition, by arranging the low voltage J/B 42 which distributes the low voltage power in the vicinity of the high voltage battery pack 10B, the wiring route of wire harness and other cables can be freely determined in a form that spreads from the center of the vehicle body to each part of the vehicle body. Therefore, the structure and shape of the wire harness can be simplified and the length and weight of each electric wire configuring the wire harness can be easily reduced.

In particular, as illustrated in FIG. 2, when the DC/DC converter 16 and the low voltage J/B 17 are built in the high voltage battery pack 10A, most of the main functions of the power supply are present in the high voltage battery pack 10A. For this reason, with respect to cables (high voltage wiring 15A, low voltage wiring 18C, and the like) which connect both high-voltage and low-voltage loads, it becomes possible to simply determine the wiring route and length around the position of the high voltage battery pack 10A.

Further, as in the configuration illustrated in FIG. 4, the master ECU EMI and the slave ECUs ES01 to ES05 having a communication function and a power supply control function are respectively arranged in the high voltage battery pack 10C and each of the modules M01 to M05. As a result, it is possible to intensively perform the cooperative control the entire vehicle with the master ECU EMI. For example, the master ECU EMI can appropriately perform control for the difference in the types, the specification change, and the like of each of the modules MO 1 to M05 connected to each part of the high voltage battery pack 10C.

Further, as illustrated in FIGS. 5 and 6, by connecting the low voltage battery 33A as the standby power supply, even when an abnormality occurs in the power supply from the high voltage system such as the high voltage battery 11 to the low voltage system, the power of the standby power source can be supplied to each load of the low voltage system.

Also, as illustrated in FIG. 7, by connecting the high voltage battery pack 10D arranged at the center of the vehicle body 100 and each of the modules M01 to M05 of each part of the vehicle body using the high-voltage cable CH or the low-voltage cables CL, it is possible to secure the power supply path of each module with a simple connection form. In addition, since connection can be performed only with two types of cables (CH, CL), the increase in the types and product numbers of parts in the wire harness can be suppressed.

In a case of the configuration illustrated in FIG. 8A, since the high voltage battery pack 10D and each of the modules M01 to M05 can be connected using the common cables CS having the same configuration, the types and product numbers of the parts in the wire harness are reduced. Furthermore, it is possible to reduce the cost of parts and the number of work steps in cable installation work. In addition, it is possible to prevent an installation error during work.

In addition, when the signal lines 93 and the sheath/braided layer 94 are included in addition to the power supply line 91 and the ground line 92 in the electric wire of the common cable CS as illustrated in FIG. 8C, a communication path between each module and the high voltage battery pack 10D can also be secured only by connecting the common cable CS.

When the module cables CM01 to CM05 are integrated with each of the modules M01 to M05 as in the configuration illustrated in FIG. 9, by simply connecting the connector CMb of each of the module cables CM01 to CM05 to the high voltage battery pack 10D, the power supply path and communication path for each module can be secured. Therefore, the number of work steps can be reduced.

Further, when the DC/DC converter 16 and the low voltage J/B 17 are unitized as in the configuration illustrated in FIG. 10, it becomes easy to dispose a plurality of low voltage units UL1 to UL4 in a dispersed state at various positions (especially in the vicinity of the outer edge) of the high voltage battery pack 10E. Therefore, it is possible to extract the low voltage power from various positions on the high voltage battery pack 10E, and the length of the cable connecting the low voltage load arranged in each part of the vehicle body and the high voltage battery pack 10E can be shortened.

In addition, when the inverters 22F and 22R are built in the high voltage battery pack 10F as in the configuration illustrated in FIG. 11, noise generated when the inverters 22F and 22R perform switching of high voltage and large current can be shielded by the metal cover which covers the high voltage battery pack 10F. Therefore, it is possible to reduce the influence of noise on the low-voltage-based equipment outside the high voltage battery pack 10F. Furthermore, by placing the inverters 22F and 22R in the vicinity of the high voltage J/Bs 12F and 12R, when installing an in-wheel motor on each wheel, it becomes easy to drive the drive motors 23FL, 23FR, 23RL, and 23RR of a plurality of wheels with the common inverters 22F and 22R. As a result, the number of inverters can be reduced.

Further, when the AC/DC converter 51 and the non-contact charging unit 52 are built in the high voltage battery pack 10G as in the configuration illustrated in FIG. 12, the positioning work of the non-contact charging unit 52 with respect to the vehicle body is facilitated. In addition, the metal cover which covers the high voltage battery pack 10G can protect the power receiving coil and the like of the non-contact charging unit 52 from physical interference and collision with an obstacle on the road surface side.

Here, the features of the embodiments of the power supply system according to the invention described above are summarized and listed in the following [1] to [12].

[1] A power supply system (see FIGS. 2 and 3) which includes

a high voltage battery (11);

a high-voltage power distribution unit (high voltage J/B 12A) that distributes high-voltage power supply from the high voltage battery:

a power conversion unit (DC/Dc converter 16) that converts high-voltage power supply supplied from the high-voltage power distribution unit to low-voltage power supply; and

a low-voltage power distribution unit (low voltage J/B 17) that distributes low-voltage power supply from the power conversion unit, where

the high-voltage power distribution unit branches output into at least two systems and distributes the high-voltage power supply to a drive module (drive motor module 20A) for driving a vehicle by power of the high-voltage power supply and to the power conversion unit (DC/DC converter 16 or 41).

[2] The power supply system (see FIG. 4) according to [1] described above, further including

a second control unit (master ECU EM1) that communicates with a first control unit (slave ECU ES01 to ES05) included in the drive module to control power supply to the drive module.

[3] The power supply system (see FIGS. 5 and 6) according to [1] or [2] described above, further including

a low voltage battery (33A), where

the low-voltage power distribution unit branches into two systems and low-voltage power supply is supplied from the power conversion unit and the low voltage battery.

[4] The power supply system (see FIG. 7) according to any one of [1] to [3] described above, where

the high-voltage power distribution unit and the drive module that requires power of the high-voltage power supply are connected via a high-voltage cable (high-voltage cable CH),

the low-voltage power distribution unit and a low-voltage module (modules M02 to M05) including a predetermined load which requires power of the low-voltage power supply are connected via a low-voltage cable (low voltage cable CL), and

the drive module and the low-voltage module are respectively connected to the power supply systems in units of modules.

[5] The power supply system (see FIG. 8C) according to [4] described above, where

the high-voltage cable and the low-voltage cable include one power supply line, one ground line, and a communication line.

[6] The power supply system (see FIG. 7) according to [4] or [5] described above, where

the high-voltage cable and the low-voltage cable have different specifications.

[7] The power supply system (see FIG. 7) according to [6] described above, where

a plurality of the drive modules which require power of the high-voltage power supply use the high-voltage cable in common and the low-voltage modules which require power of the low-voltage power supply use the low-voltage cable in common.

[8] The power supply system (see FIG. 8A) according to [4] or [5] described above, where

the high-voltage cable and the low-voltage cable are configured of a common electric wire (common cable CS) and common connectors (common connectors CSa, CSb) are provided at both ends of the electric wire, and

each of the high-voltage power distribution unit and the low-voltage power distribution unit is provided with a common insertion port (common connector CN1S) which is fitted to the connector.

[9] The power supply system (see FIG. 9) according to [4] or [5] described above, where

the high-voltage cable and the low-voltage cable are configured of a common electric wire (module cables CM01 to CM05), one end (cable end portion CMa) of the electric wire is extended from the drive module or the low-voltage module, and a common connector (CMb) is provided at the other end of the electric wire, and

each of the high-voltage power distribution unit and the low-voltage power distribution unit is provided with a common insertion port (common connector CN1S) which is fitted to the connector.

[10] The power supply system (see FIG. 10) according to any one of [1] to [9] described above, where

a plurality of units (low voltage units UL1 to UL4) each including the power conversion unit (DC/DC converter 16) and the low-voltage power distribution unit (low voltage J/B 17) are provided.

[11] The power supply system (see FIG. 11) according to any one of [1] to [10] described above, further including

a power supply circuit (inverter 22F, 22R) which converts direct current to alternating current, where

the power supply circuit converts the high-voltage power supply supplied from the high-voltage power distribution unit into alternating current and supplies the alternating current to the drive module (drive motors 23FL, 23FR, 23RL, 23RR).

[12] The power supply system (see FIG. 12) according to any one of [1] to [11] described above, further including

a non-contact charging unit (52).

Although the invention has been described in detail and with reference to specific embodiments, it will be apparent to those skilled in the art that various changes and modifications can be made without departing from the spirit and scope of the invention.

According to the invention, while maintaining high design flexibility when examining the layout of the power supply system in the passenger compartment, there is an effect that it is possible to suppress an increase in the length of the power supply line connected to the indoor device (low-voltage-based device such as 12V). The invention having the effect is useful for a power supply system suitable for power supply on a vehicle.

What is claimed is:

1. A power supply system comprising:
a high voltage battery;
a high-voltage power distribution unit that distributes high-voltage power supply from the high voltage battery;
a power conversion unit that converts high-voltage power supply supplied from the high-voltage power distribution unit to low-voltage power supply; and
a low-voltage power distribution unit that distributes low-voltage power supply from the power conversion unit, wherein
the high-voltage power distribution unit branches output into at least two systems and distributes the high-voltage power supply to a drive module for driving a vehicle by power of the high-voltage power supply and to the power conversion unit, and
the high voltage battery, the high-voltage power distribution unit, the power conversion unit, and the low-voltage power distribution unit are incorporated in a high voltage battery pack disposed outside the drive module, or
the high voltage battery and the high-voltage power distribution unit are incorporated in a high voltage battery pack disposed outside the drive module, and the power conversion unit and the low-voltage power distribution unit are incorporated in a converter module disposed outside the drive module and the high voltage battery pack.

2. The power supply system according to claim 1, further comprising
a second control unit that communicates with a first control unit included in the drive module to control power supply to the drive module.

3. The power supply system according to claim 1, further comprising
a low voltage battery, wherein
the low-voltage power distribution unit branches into two systems and low-voltage power supply is supplied from the power conversion unit and the low voltage battery.

4. The power supply system according to claim 1, wherein
the high-voltage power distribution unit and the drive module that requires power of the high-voltage power supply are connected via a high-voltage cable,
the low-voltage power distribution unit and a low-voltage module including a predetermined load which requires power of the low-voltage power supply are connected via a low-voltage cable, and
the drive module and the low-voltage module are respectively connected to the power supply system in units of modules.

5. The power supply system according to claim 4, wherein
the high-voltage cable and the low-voltage cable include one power supply line, one ground line, and a communication line.

6. The power supply system according to claim 4, wherein
the high-voltage cable and the low-voltage cable have different specifications.

7. The power supply system according to claim 6, wherein
a plurality of the drive modules which require power of the high-voltage power supply use the high-voltage cable in common, and the low-voltage modules which require power of the low-voltage power supply use the low-voltage cable in common.

8. The power supply system according to claim 4, wherein
the high-voltage cable and the low-voltage cable are configured of a common electric wire and common connectors are provided at both ends of the electric wire, and
each of the high-voltage power distribution unit and the low-voltage power distribution unit is provided with a common insertion port which is fitted to the connector.

9. The power supply system according to claim 4, wherein
the high-voltage cable and the low-voltage cable are configured of a common electric wire, one end of the electric wire is extended from the drive module or the low-voltage module, and a common connector is provided at the other end of the electric wire, and
each of the high-voltage power distribution unit and the low-voltage power distribution unit is provided with a common insertion port which is fitted to the connector.

10. The power supply system according to claim 1, wherein
a plurality of units each including the power conversion unit and the low-voltage power distribution unit are provided.

11. The power supply system according to claim 1, further comprising
a power supply circuit which converts direct current to alternating current, wherein
the power supply circuit converts the high-voltage power supply supplied from the high-voltage power distribution unit into alternating current and supplies the alternating current to the drive module.

12. The power supply system according to claim 1, further comprising
a non-contact charging unit.
